(19) United States
(12) Patent Application Publication
(10) Pub. No.: US 2005/0092946 A1
(43) Pub. Date: May 5, 2005

(54) Automatically calibrating vacuum relief safety valve

(76) Inventors: George Fellington, Vero Beach, FL (US); Marwood Ruschell, Okeechobee, FL (US); Paul Pennington, Santa Rosa, CA (US)

Correspondence Address: RUDEN, MCCLOSKY, SMITH, SCHUSTER & RUSSELL, P.A., P.O. BOX 1900, FORT LAUDERDALE, FL, 33301, US

(21) Appl. No.: 10/980,031

(22) Filed: Nov. 3, 2004

Related U.S. Application Data
(60) Provisional application No. 60/517,033, filed on Nov. 4, 2003.

(51) Int. Cl. F16K 31/12; B22D 46/00

(52) U.S. Cl. 251/48

(57) ABSTRACT

An automatically calibrating vacuum relief safety valve is disclosed including a valve body having a plurality of inner cavities, wherein a first cavity of said plurality of inner cavities is in constant fluid communication with air external to said valve body and wherein a second cavity of said plurality of cavities is in intermittent fluid communication with said first cavity, at least one air vent opening positioned between said first cavity and said second cavity and operatively engaged to a releasable seal, said releasable seal connected to a piston member, and a check valve in fluid communication with said second cavity and the suction side of a pump.

### CROSS-REFERENCE TO RELATED APPLICATIONS

This application claims the benefit of U.S. Provisional Application Ser. No. 60/517,033, filed on Nov. 4, 2003, entitled AUTOMATICALLY CALIBRATING VACUUM RELIEF SAFETY VALVE.

### TECHNICAL FIELD

The present invention generally relates to relief valves. More particularly, the invention relates a vacuum relief safety valve adapted for use on a suction line of a swimming pool filter pump system. The safety valve of the present invention causes air to enter the pump system, thereby releasing the system vacuum in the event a predetermined vacuum level is reached, such as when an object obstructs the main drain of a pool. Consequently, the safety valve serves as a safety device to eliminate pump suction if a child becomes trapped by the suction of the filter pump.

### BACKGROUND OF THE INVENTION

There have been numerous cases of serious injuries and deaths caused by high vacuum levels at a pool's drain port that holds, an individual to the drain port. When such an incident occurs, the vacuum level in the drain line leading from the drain port to the pool's pump rises sharply.

Various safety valves have been developed in which the high vacuum level occurring during such incidents is sensed and used to trip the valve and allow air to bleed into the drain line, causing the pump to lose prime. Although such valves function to some degree, they generally exhibit three problems. The first is they are often set at the factory to a predetermined trip level that does not always correspond to an appropriate level for a particular pool. Variations in pumps, pipe diameters, pipe length and the number of turns and pitches in a pipe line, all affect the vacuum level at which a safety valve's trip level should be set. This setting is best done at the pool site.

Another problem is related to the reliability of the valve. Virtually all valves include gaskets that must remain sealed if the valve is to function properly. If a gasket becomes dislodged from its seat, it can allow air to leak around the closure elements of the valve, causing the pump to lose prime when there is no emergency. This effectively shuts down the pool and can only be remedied by removing the valve and having it repaired, which often requires the valve to be returned to the factory.

Yet another issue pertaining to present safety valves, such as the valve of U.S. Pat. No. 5,682,624 issued to Ciochetti, is the incorporation of a feature or element that prevents rapid cycling of the valve. Such an element prevents the valve from resetting itself too quickly, resulting in the total loss of prime in the pump used to provide the vacuum. In such a state, the pump forces air through the system rather than water, resulting in the pump becoming severely damaged or destroyed due to the decreased load.

Thus, there is a need for a safety valve that prevents a complete loss of prime and that eliminates the need for manual experimentation and calibration of the valve to enable a diaphragm to lift a seat in response to a maximum allowable vacuum level.

### SUMMARY OF THE INVENTION

The present invention eliminates the above-mentioned needs for an automatically calibrating vacuum relief safety valve by providing an automatically calibrating vacuum relief safety valve that includes a pre-calibrated diaphragm system that eliminates the need for manual experimentation and calibration of the valve and prevents a complete loss of prime to the pump.

In accordance with the present invention, there is provided an automatically calibrating vacuum relief safety valve that includes a valve body having a plurality of inner cavities, wherein a first cavity of the plurality of inner cavities is in constant fluid communication with air external to the valve body and wherein a second cavity of the plurality of cavities is in intermittent fluid communication with the first cavity, at least one air vent opening positioned between the first cavity and the second cavity and operatively engaged to a releasable seal, the releasable seal connected to a piston member, and a check valve in fluid communication with the second cavity and a suction side of a pump.

### BRIEF DESCRIPTION OF THE FIGURES

FIG. 1 is a cross-sectional side view illustration of the preferred embodiment of the present invention in the closed position.

FIG. 2 is a cross-sectional side view illustration of the preferred embodiment of FIG. 1 in the open position.

### DETAILED DESCRIPTION OF THE PREFERRED EMBODIMENT

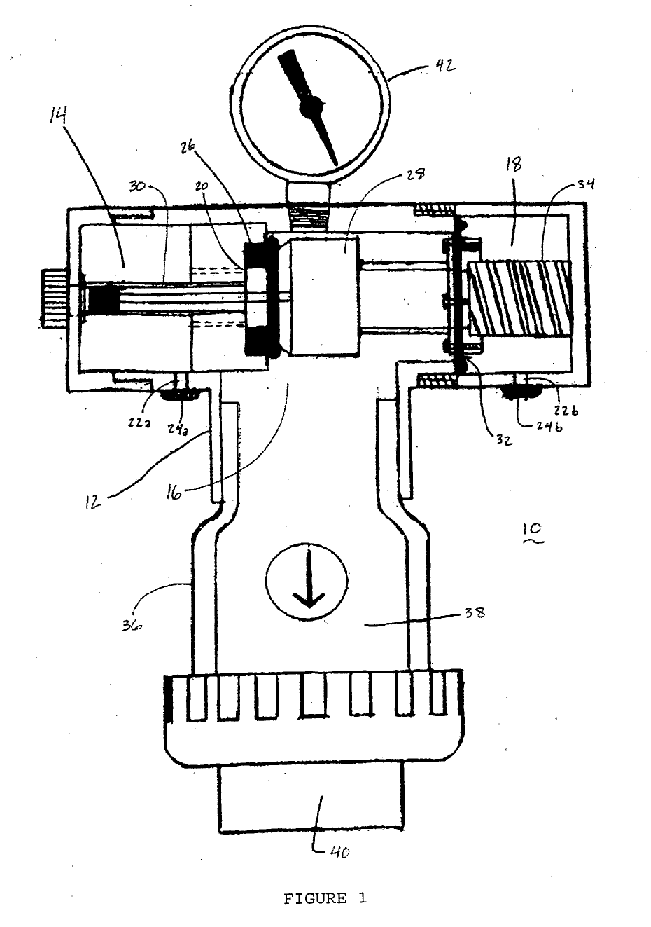

Referring now to FIG. 1, the preferred embodiment of the present invention is illustrated as automatically calibrating vacuum relief safety valve 10. Automatically calibrating vacuum relief safety valve 10 includes a valve body 12 and a plurality of cavities, including first cavity 14 and second cavity 16. Additionally, as shown in FIG. 1 and described in detail below, a third cavity can be incorporated as well.

It is preferred that first cavity be in constant fluid communication with the air external to valve body 12. In this manner, the air internal to first cavity 14 can have an atmospheric pressure substantially equal to the atmospheric pressure of the air surrounding the outside of valve body 12. This substantial equalization of air pressures is accomplished by incorporating a vent, such as vent 22a or 22b, into a portion of valve body 12, with vent 22a passing through valve body 12 and providing constant fluid communication between first cavity 14 and the air external to valve body 12.

Preferably, at least one air vent opening 20 is provided to permit intermittent fluid communication between first cavity 14 and second cavity 16, as further detailed below. Air vent opening 20 is releasably sealed to and operatively engages seal 26 to prevent premature fluid communication between first cavity 14 and second cavity 16.

Seal 26 engages air vent opening 20 and is further engaged to piston member 28. As piston member 28 slides towards diaphragm 32 (as described in detail below), seal 26 releases its engagement with piston member 28, thereby permitting fluid communication between first cavity 14 and second cavity 16 through air vent opening 20.

Piston member 28 is operatively engaged to a dash pot 30. As detailed further below, a dash pot, such as dash pot 30 having a plunger 31 and a plunger shaft 33, is employed so that when vacuum pressure in second cavity 16 returns to an appropriate level, the return action of piston member 28 is delayed by means of a buffer action of a dash pot. Thus, piston member 28 gradually returns to a position that permits it to re-engage seal 26 and air vent opening 20 to thereby prevent the reoccurrence of an inappropriate vacuum pressure level in second cavity 16.

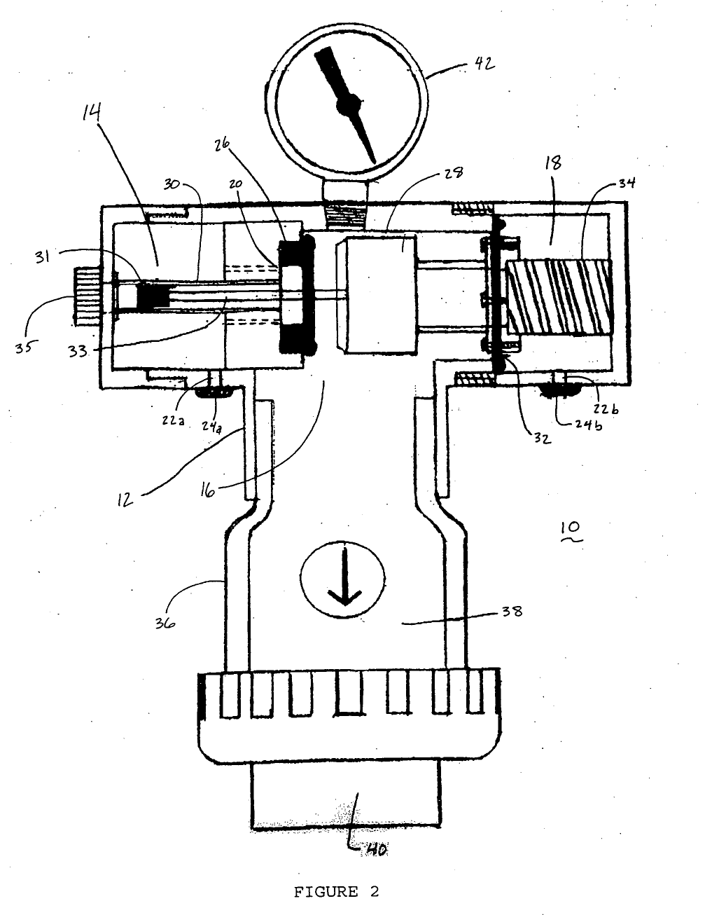

In operation, as is illustrated in FIGS. 1 and 2, when a blockage is created in a circulation system incorporating valve 10, vacuum pressure increases in second cavity 16 of valve 10. Vacuum pressure increases as a result of the use of a check valve 38 that is connected to valve body 12 by way of check valve body 36. Check valve body 36 is further connected to a suction side of a circulation system pump (not shown). Once a blockage is created in the circulation system, check valve 38 prevents the return of water or other fluid into second cavity 16.

This increase in vacuum pressure is transmitted throughout second cavity 16 and causes diaphragm 32 to be drawn and flex further away from second cavity 16 and into third cavity 18, resulting in additional air to be pushed out of third cavity 18 by way of vent 22b and vent screen 24b. By allowing air to be pushed out of third cavity 18, diaphragm 32 is drawn further into third cavity 18.

Once the maximum allowable pressure is reached, as indicated to a user by way of vacuum gauge 42 and which is a predetermined function of diaphragm 32, diaphragm spring 34, and the strength of the frictional engagement between seal 26 and piston member 28, the frictional engagement between seal 26 and piston member 28 releases, resulting in a release of the seal between seal 26, piston member 28, and air vent opening 20. The frictional engagement between seal 26 and piston member 28 releases once the vacuum pressure in second cavity 16 reaches a level sufficient to cause the pressure differential between the air pressure within first cavity 14 and second cavity 16 to cause the air pressure in second cavity 16 to push diaphragm 32 further into third cavity 18. As diaphragm 32 is pushed further into third cavity 18, it travels in connection with piston member 28 towards third cavity 18. Thus, as diaphragm 32 travels into third cavity 18, compressing spring 34, piston member 28 is drawn towards third cavity 18 as well.

As a result, once piston member 28 is pulled out of engagement with seal 26 and air vent opening 20, air is then permitted to flow through vent 22a and vent screen 24a, through first cavity 14, then through air vent opening 20 and into second cavity 16, through check valve 38 and into the suction side of a circulation system pump, thereby reducing the vacuum pressure in the system. In this way, once the vacuum pressure is sufficiently reduced, an individual or object that is trapped by the suction of the circulation system, and resulting vacuum pressure build-up, can be released.

Once the vacuum pressure in the system has been sufficiently reduced, spring 34 returns diaphragm 32 to its normal state, thereby pushing piston member 28 back into engagement with seal 26.

To prevent the person or object from becoming trapped again too quickly, piston member 28 is affixed to plunger 31 by plunger 33 of dash pot 30 so as to cause piston member 28 and diaphragm 32 to return towards and engage air vent opening 20 slow enough to fully permit escape by the person or object previously held by the vacuum pressure of the circulation system. The return movement of piston member 28 results from the movement of associated plunger 31 and plunger shaft 33 to which it is operatively engaged. The return movement of piston member 28 and associated plunger 31 and plunger shaft 33 can be adjusted by bleed valve adjustment knob 35, as is known in the art. Thus, by using dash pot 30, with associated plunger 31 and plunger shaft 33 operatively engaged to piston member 28, valve 10 automatically resets itself without the need for manual recalibration.

Accordingly, the preferred embodiment of the present invention provides for a valve for preventing a person or an object from being trapped by vacuum pressure to a drain or any other suction line of a swimming pool filtration pump system. In particular, the present invention provides a valve capable of causing the filter pump to immediately reduce, but not eliminate, its prime when a person or object obstructs or becomes trapped against the drain or suction line inlet of a swimming pool, so that the vacuum created by the filtration pump is sufficiently reduced to a level that permits escape from the vacuum source. The valve of the present invention is constructed as a vacuum relief valve that can be mounted directly to the suction side of a circulation pump that is fluidically interconnecting the pool's main drain and suction lines with the circulation pump. The preferred embodiment is constructed to permit air to rapidly flow into the drain and suction lines if a predetermined vacuum level is exceeded within the lines, as is the case if the drain or one of the pool's suction line inlets becomes partially or completely obstructed. The rapid influx of air sufficiently reduces the vacuum within the lines and, therefore, the resulting unsafe condition. The response of valve 10 is preferably dampened such that valve 10 will remain open sufficiently long enough to cause the filter pump to reduce its prime sufficiently to reduce the resulting vacuum pressure, but not resulting in a complete loss of prime.

In view of the above, it can be seen that a significant advantage of the present invention is that an existing pool can be readily retrofitted with the preferred embodiment of valve 10 by mounting valve 10 to the pool's existing circulation system. Consequently, this invention does not necessitate that the pool's drain be modified or reconstructed, such that the benefits of the invention can be realized without draining the pool and performing extensive and expensive structural work on the pool. Instead, the invention can be implemented by installing the present invention outside of the pool, such as near the circulation pump. Accordingly, a related advantage of this invention is that the flow characteristics at the pool drain are not reduced or altered in order to reduce the hazard level posed by a high capacity filter pump system. Instead, this invention serves to completely eliminate the hazard by venting the suction line to atmosphere if appropriate circumstances arise. Thus, the drain can be optimally designed to perform its intended function of efficiently removing water and debris from the pool, since the drain design does not detract or contribute significantly to the operation of the present invention.

Although only a few exemplary embodiments of the present invention have been described in detail above, those skilled in the art will readily appreciate that numerous modifications are to the exemplary embodiments are possible without materially departing from the novel teachings and advantages of this invention. Accordingly, all such modifications are intended to be included within the scope of this invention as defined in the following appended claims.

1. An automatically calibrating vacuum relief safety valve, comprising:
a valve body having a plurality of inner cavities, wherein a first cavity of said plurality of inner cavities is in constant fluid communication with air external to said valve body and wherein a second cavity of said plurality of cavities is in intermittent fluid communication with said first cavity;
at least one air vent opening positioned between said first cavity and said second cavity and operatively engaged to a seal, said seal releasable connected to a piston member; and
a check valve in fluid communication with said second cavity and a suction side of a pump.

2. The automatically calibrating vacuum relief safety valve of claim 1 wherein said second cavity is in intermittent fluid communication with said first cavity by said at least one air vent opening.

3. The automatically calibrating vacuum relief safety valve of claim 1 wherein said piston member is operatively engaged to a diaphragm.

4. The automatically calibrating vacuum relief safety valve of claim 1 wherein said piston member is operatively engaged to a second piston.

5. The automatically calibrating vacuum relief safety valve of claim 3 wherein said diaphragm is movable.

6. The automatically calibrating vacuum relief safety valve of claim 5 wherein said piston member moves in connection with said diaphragm.

7. The automatically calibrating vacuum relief safety valve of claim 6 wherein said piston member is operatively engaged to a plunger and plunger shaft of dash pot.

8. The automatically calibrating vacuum relief safety valve of claim 7 wherein said piston member returns to a resting state when said diaphragm returns to a resting state.

9. The automatically calibrating vacuum relief safety valve of claim 8 wherein said piston member returns to said resting state at a variable speed.

10. The automatically calibrating vacuum relief safety valve of claim 9 wherein said variable speed is determined by a bleed valve adjustment knob.

11. The automatically calibrating vacuum relief safety valve of claim 10 wherein said bleed valve adjustment knob adjusts the speed of said plunger to a resting state.

12. An automatically calibrating vacuum relief safety valve, comprising:
a valve body having a plurality of inner cavities, wherein a first cavity and a third cavity of said plurality of inner cavities is in constant fluid communication with air external to said valve body and wherein a second cavity of said plurality of cavities is in intermittent fluid communication with said first cavity;
at least one air vent opening positioned between said first cavity and said second cavity and operatively engaged to a seal, said seal releasable connected to a piston member;
a movable diaphragm operatively engaged to said piston and positioned between said second cavity and said third cavity, said piston further operatively engaged to a movable plunger and plunger shaft of dash pot; and
a check valve in fluid communication with said second cavity and a suction side of a pump.
